(19) United States
(12) Patent Application Publication
(10) Pub. No.: US 2008/0231987 A1
(43) Pub. Date: Sep. 25, 2008

(54) Disk Cartridge Having Centering Means

(75) Inventor: Waltherus Cornelis Jozef Bierhoff, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,176

(22) PCT Filed: Jan. 14, 2005
(86) PCT No.: PCT/IB2005/050172

§ 371 Date: Jul. 14, 2006

(30) Foreign Application Priority Data
Jan. 19, 2004 (EP) 04100137.1

(51) Int. Cl. G11B 15/68

(52) U.S. Cl. 360/92.1

(57) ABSTRACT

A disk cartridge comprises a disk (1) having a central hub (4) for engagement with a disk drive. The disk is accommodated in a housing (2). The housing and disk are dimensioned such that there is limited clearance in a direction parallel to and perpendicular to the plane of the disk. The cartridge comprises a clamping member (11), such as a magnet, to clamp the disk to one side of the cartridge housing when the cartridge is free from the disk drive. The housing and the disk have co-operating centering members (13, 14), preferably near the center of the disk, so as to center the disk with respect to the cartridge housing when the disk is clamped to the housing by the clamping member. In this way, the disk is always in the correct position for a next engagement by the disk drive.

### BACKGROUND OF THE INVENTION

1. Field of the Invention

The present invention relates to a disk cartridge, comprising a disk having a central hub for engagement with a disk drive to drive the disk into rotation and a cartridge housing in which the disk is rotatably accommodated, the housing and disk being dimensioned such that there is limited clearance in a direction parallel to and substantially perpendicular to the plane of the disk, wherein the cartridge comprises a clamping member to clamp the disk to one side of the cartridge housing when the cartridge is free from the disk drive.

2. Description of the Related Art

The prior art discloses disk cartridges having a magnet as a clamping member to clamp the disk to one side of the cartridge housing when the cartridge is free from the disk drive. The magnet is attached to the housing and is adapted to attract the hub of the disk, see for example U.S. Pat. No. 5,090,010.

It is an object of the present invention to provide an improved disk cartridge.

### SUMMARY OF THE INVENTION

According to the invention, the cartridge housing and the disk drive have co-operating centering members for centering the disk with respect to the cartridge housing when the disk is clamped to the housing by the clamping member. The disk cartridge according to the invention is defined in claim 1.

Owing to the centering members, the disk is always displaced into a central position in radial direction when the disk is moved to one side of the cartridge housing by the clamping member. The effect of this is that the disk is always in the correct position for a next engagement with the disk drive. This facilitates the engagement between an engagement member of the disk drive and the hub of the disk. This is especially important in small disk drives having limited abilities to take up tolerances in the disk cartridge.

According to the embodiment defined in claim 2, there is a conical portion which creates the centering effect. This is a simple means for performing this function. In the embodiment defined in claim 3, the centering function is performed near the center of the disk, as close as possible to the part of the disk that is engaged by the disk drive.

The embodiment defined in claim 4 leads to a very simple structure, most disks having cup-shaped hubs, so that a standard disk may be used.

An effective and simple clamping member is defined in claim 5.

An advantageous embodiment of the invention is defined in claim 6. In this embodiment, the clamping and centering functions are both performed by the magnetized element, leading to a very simple yet effective structure of the clamping and centering means.

Claim 7 defines a further advantageous embodiment. The linear contact between the hub and the magnetized element provides a sufficiently strong clamping force between the disk and the cartridge, yet the contact is easily broken when the disk is to be displaced into the operating position within a disk drive.

These and other aspects of the invention are apparent from and will be elucidated with reference to the example described hereinafter.

### BRIEF DESCRIPTION OF THE DRAWINGS

In the drawings:

FIG. 1 is a cross-sectional view of an embodiment of a disk cartridge according to the invention, showing the disk in an operational position, i.e. when the cartridge is positioned in a disk drive.

FIG. 2 shows detail II in FIG. 1 on an enlarged scale.

FIGS. 3 and 4 are views similar to those of FIGS. 1 and 2, but illustrating the disk in a clamped position of rest.

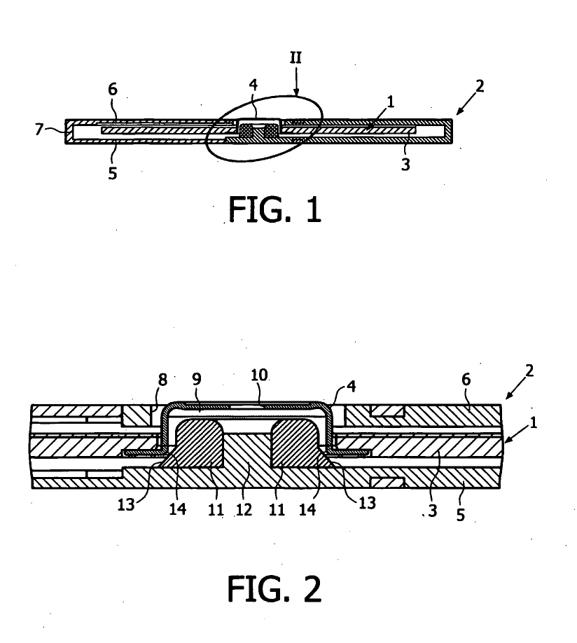

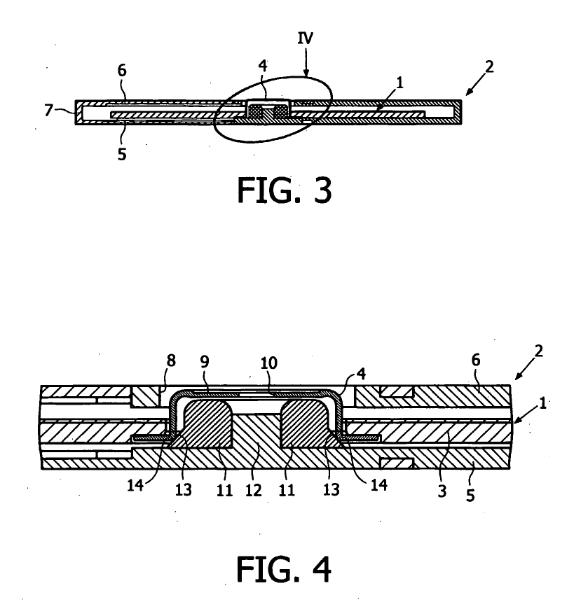

### DETAILED DESCRIPTION OF THE PRESENTLY PREFERRED EMBODIMENTS

The drawings show an embodiment of a disk cartridge. The main components of this disk cartridge are a disk 1 and the cartridge housing 2. The disk comprises a data carrying plastic part 3 and a central metal hub 4 connected to the portion 3, for example by gluing or any other suitable method of attachment. In the embodiment shown, the disk 1 is an optical disk, in particular a blue-ray disk having a small diameter, for example circa 20-40 mm. The disk is intended to co-operate with a disk drive in order to allow a pick-up unit to read data from the disk and/or to write data onto the disk.

The disk 1 is rotatably accommodated in the housing 2. The housing 2 comprises two substantially plane walls 5 and 6, extending parallel to each other and to the accommodated disk 1, and a circumferential wall 7 interconnecting the walls 5 and 6. The circumferential shape of the housing 2 may be circular, square or any other suitable shape. The housing 2 is preferably as thin as possible. The housing 2 will normally have a (closable) opening (not shown) in order to allow an optical pick-up unit to gain access to the information on the data carrying portion 3 of the disk 1. Alternatively, the housing may be constructed from several movable parts for opening and closing the housing.

In the center of the housing 2, a hub opening 8 is formed in the wall 6. This hub opening 8 allows a shaft of the disk drive to come into engagement with the hub 4 of the disk 1.

As is shown in the drawings, the hub 4 is cup-shaped (upside down in the drawings) and the bottom 9 of the hub 4 is provided with an engagement means 10, for example including a central opening and a further eccentric opening (not shown). The hub 4 extends partially into the hub opening 8.

As is apparent from FIGS. 2 and 4, the disk 1 and the housing 2 are dimensioned such that there is a limited clearance in a direction substantially perpendicular to the plane of the disk and in a direction parallel to the plane of the disk 1. This clearance is necessary to allow rotation of the disk 1 when it is engaged by the disk drive, without interference by the walls 5-7 of the housing 2. This clearance, however, could lead to undesired movements of the disk 1 in the housing 2 when the disk cartridge is free from the disk drive. This may lead to rattling and undesirable wear of and scratches and dust on the disk 1.

In order to prevent the disk 1 from moving within the housing 2 when it is not in engagement with the disk drive, a clamping means is provided to clamp the disk 1 to one side of the cartridge housing 2 when the cartridge is free from the disk drive. In this embodiment, the clamping means or member is a magnetized element, here a permanent magnet 11. The magnet 11 has an annular shape, and the axis of the magnet 11 is aligned with the desired axis of rotation of the disk 1. The magnet 11 is fixed to the wall 5, in this case by means of a projection 12 on the housing wall 5 which enters into the central opening of the annular magnet 11. Glue or other adhering means fixes the magnet 11 to the wall 5.

The magnet 11 has a circular cross-section and, in the portion adjacent to the wall 5, the magnet 11 is provided with a conical centering portion 13, this portion 13 tapering from the wall 5 towards the other wall 6. The conical portion 13 is intended to co-operate with the inner edge 14 of the magnetizable, e.g. steel, cup-shaped hub 4. For this purpose, the largest diameter of the conical portion 13 is larger than the diameter of the edge 14 while the smallest diameter of the conical portion is smaller than the diameter of the edge 14.

The function of the centering portion 14 is to center the disk when the disk 1 is attracted by the magnet 11 in order to be clamped in its position of rest, while the cartridge is outside the disk drive. The disk 1 is clamped in its correct radial position with respect to the housing by this centering effect. This facilitates a new engagement of the disk 1 by the disk drive, as the engagement means of the disk drive will be correctly aligned with the engagement means of the disk if the cartridge housing is correctly positioned in the disk drive. When the disk is moved from the clamped position to the operational drive position according to FIG. 2, the hub 4 moves away from the magnet 11, and a clearance is created between the hub 4 and the magnet 11, both in axial and radial directions, so as to allow rotation of the disk 1 without contact with the housing 2. In its clamped position, the hub 4 and the magnet 11 are in linear contact at the position of the edge 14, and this linear contact allows a sufficient clamping force, but also allows an easy withdrawal of the hub 4 from the magnet 11 by the disk drive.

It will be apparent from the foregoing that the invention provides a disk cartridge having very simple yet effective means for clamping and centering the disk in its rest position when the cartridge is free from a disk drive.

Several variations and alternatives of the embodiment as shown are conceivable. For example, the centering means may be provided separate from the magnet, for example as part of the housing wall. Furthermore, the conical portion could be formed on the hub of the disk. The conical portion of the housing may also co-operate with the outer circumference of the disk, although the centering effect is more accurate if is performed near the center of the disk. In the clamped position, it is not necessary to have a direct contact between the hub and the magnet, especially if the centering means is not integrated in the magnet.

Instead of a magnetized element, the clamping member may alternatively include a mechanical clamping member, in particular spring means. An operating mechanism for this spring means may project through the housing wall in order to deactivate the spring means when the cartridge is loaded in the disk drive and activate it again when the cartridge is freed from the disk drive.

It is noted that the use of the expressions “a” or “an” in the specification and claims does not exclude a plurality the respective elements, and the expression “comprising” does not exclude additional elements or steps.

In the depicted embodiment, the disk is an optical data disk. However, it should be understood that the invention may also be used for all kinds of other disks, e.g. ferro-electric, magnetic, magneto-optical, near-field, active charge storage disks, or other disks using combinations of these techniques or other reading and/or writing techniques.

With reference to the claims it is to be noted that various characteristic features defined in the set of claims may occur in combination.

1. A disk cartridge, comprising:
a disk (1) having a central hub (4) for engagement with a disk drive to drive the disk into rotation; and
a housing (2) in which the disk is accommodated;
the cartridge comprising a clamping member (4, 11) to clamp the disk (1) to one side of the cartridge housing (2) when the cartridge is free from the disk drive,
wherein the housing (2) and the disk (1) have co-operating centering members (13, 14) for centering the disk with respect to the cartridge housing when the disk is clamped to the housing by the clamping member.

2. The cartridge of claim 1, wherein one of the housing (2) and disk (1) comprises a circumferential conical portion (13), while the respective other one has a circumferential portion (14) that can engage the conical portion.

3. The cartridge of claim 2, wherein the conical portion (13) is provided on a projection on the inner wall (5) of the housing (2), and the circumferential portion (14) of the disk (1) is provided at the hub (4).

4. The cartridge of claim 3, wherein the hub (4) is cup-shaped and the inner edge of the cup forms the circumferential portion (14) of the disk (1) co-operating with the conical portion (13) of the projection.

5. The cartridge of claim 1, wherein the clamping member (4, 11) comprises at least a magnetized element (11) and a magnetizable element (4) on the disk (1) and housing (2).

6. The cartridge of claim 3, wherein the magnetized element (11) forms the projection on which the conical portion (13) is provided, and the hub (4) is made of a magnetizable material.

7. The cartridge of claim 1, wherein the inner edge (14) of the cup-shaped hub (4) and the conical portion (13) of the magnetized element (11) are substantially in linear contact with one another when the disk (1) is clamped to the housing (2), while the remainder of the magnetized element (11) is free of the disk (1).

8. The cartridge of claim 5, wherein the magnetized element (11) is annular, and the housing wall (5) comprises a projecting portion (12) engaging the center of the annular magnetized element (11) so as to fix the magnetized element to the wall (5).
